(19) United States
(12) Patent Application Publication
(10) Pub. No.: US 2004/0006517 A1
(43) Pub. Date: Jan. 8, 2004

(54) Rental machine and storage medium

(76) Inventor: Sunao Takatori, Tokyo (JP)

Correspondence Address: Darby & Darby, 805 Third Avenue, New York, NY, 10022, US

(21) Appl. No.: 10/204,612

(22) PCT Filed: Feb. 23, 2001
(86) PCT No.: PCT/JP01/01383

(30) Foreign Application Priority Data
Feb. 23, 2000 (JP) 2000-46614

(51) Int. Cl. G06F 17/60

(52) U.S. Cl. 705/26

(57) ABSTRACT

Customer authentication, charging processing and so on may be accurately performed, in renting software which is available through communication networks such as the Internet.

In a rental machine 3, a controlling part 31 performs storage processing of the software into a PC 1, i.e. a reproducing unit for the rental software, and deleting processing of the software stored in the PC 1 at expiration of a rental contract. The controlling part 31 detects an ID code relating to the subscriber line by controlling a transmitting/receiving part 33, and so on, and executes storage processing of the software through the subscriber line corresponding to the detected ID code.

### 1. TECHNICAL FIELD

The present invention relates to a rental machine, and, especially, to a rental machine and storage medium which are applied when software is rented by using information communication networks such as the Internet.

### 2. BACKGROUND ART

With the spread of communication networks such as the Internet, various kinds of services such as purchase of books, movies, music software or application programs, or deals on the Internet malls, through the communication lines, have rapidly widespread.

As the above various kinds of services have spread, it may be expected that a means through which a user can access to information communication networks will spread to personal computers, mobile communication terminals and moreover, household electronic devices.

In the future, there is a high possibility that most of the electronic devices would be provided with a function to purchase pay commodities through the communication lines, and therefore, authentication of customers wishing to buy the commodities through the communication lines will become much more important.

When software and so on are dealt as rental commodities, electronic devices (for example, televisions, stereo systems, personal computers, and so on) for reproducing the rental commodities are different depending on the kinds of the rental commodities. When unspecified customers are going to rent software by using a common electronic device, more accurate authentication of the customers to be charged is required.

On the other hand, users may not freely install application programs into personal computers, mobile communication terminals, and so on, because they have limited memory capacities due to downsizing of commodities.

An object of the present invention is to provide a rental machine and storage medium which can perform user authentication, charging processing and so on accurately in renting software which is available through communication networks such as the Internet.

### 3. DISCLOSURE OF INVENTION

In order to accomplish the above object, a rental machine according to the present invention comprises storage means for storing software in an electronic device to reproduce the software, and deleting means for deleting the software stored in the electronic device at expiration of a rental contract.

In one aspect, the rental machine further comprises detecting means for detecting information on the subscriber line, and the storage means stores the software through the subscriber line corresponding to the information detected by the detecting means. It is possible to perform authentication for the rental (charging) based on the information specific to customers, when a number of customers use the electronic device as a reproducing unit for rental commodities.

In another aspect, the rental machine further comprises continuation means for asking acknowledgment of the rental continuation at expiration of the rental contract, and the deleting means defers deletion of the software, when the confirmation of rental continuation is performed by the continuation means. Thereby the customers can select either expiration or extension of the rental for the rented software as they like.

In still another aspect, the rental machine of the present invention comprises storage means for storing the software in an electronic device to reproduce it, and preventing means for preventing starting up of the software stored in the electronic device at expiration of a rental contract.

In yet another aspect, the present invention is a computer-readable storage medium storing programs, which makes a computer operate as a rental machine comprising the storage means and the deleting means, or the storage means and the preventing means.

The descriptions in specification and/or drawings of the Japanese Patent Application No. 2000-46614 on which the priority of the present application is based is herein incorporated by reference.

### 4. BRIEF DESCRIPTION OF DRAWINGS

FIG. 1 is a block diagram showing a configuration of the rental system including a rental machine according to an embodiment of the present invention.

FIG. 2 is a diagram for explaining a customer authentication scheme between a rental machine and a mobile communication terminal according to an embodiment of the present invention.

FIG. 3 is a block diagram showing a configuration of a rental machine according to an embodiment of the present invention.

FIG. 4 is a functional block diagram for explaining the functions of a rental machine according to an embodiment of the present invention.

FIG. 5 is a diagram for explaining a history table.

FIG. 6 is a flow chart for explaining the operations of a rental machine according to an embodiment of the present invention.

### 5. BEST MODE FOR CARRYING OUT THE INVENTION

Preferred embodiments of the present invention will be described in detail below, referring to accompanying drawings.

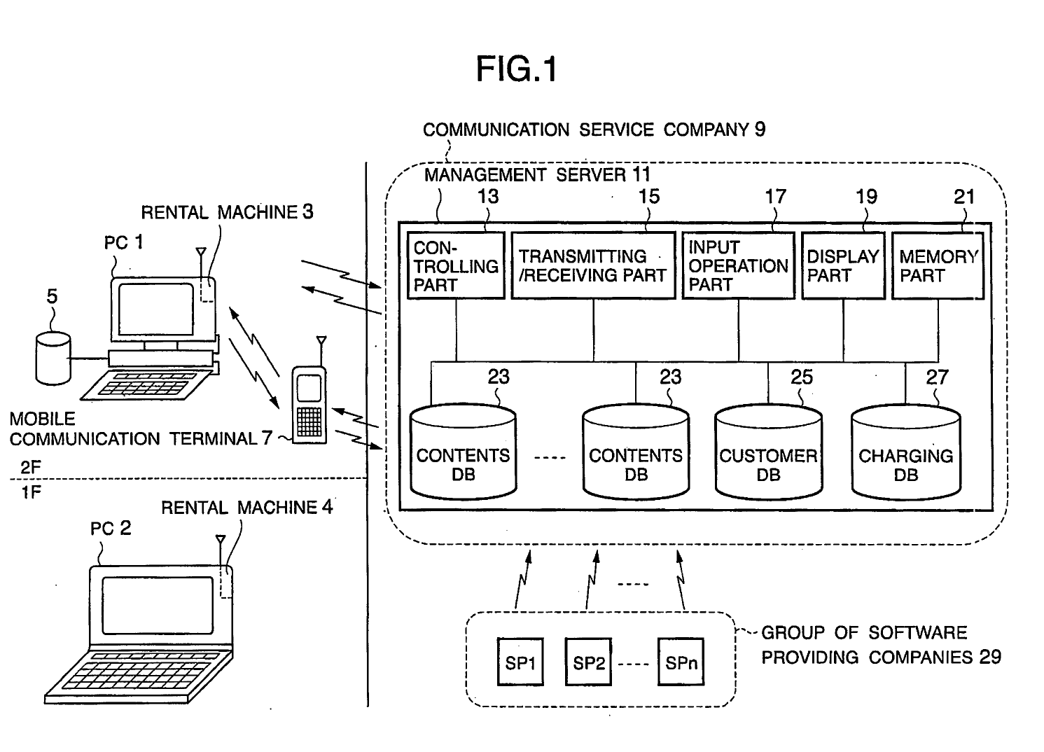

FIG. 1 is a block diagram showing a configuration of a rental system including a rental machine according to an embodiment of the present invention. Rental machines 3, 4 according to the present invention are integrated with electronic devices (personal computers (PCs) 1, 2 in FIG. 1) respectively for reproducing rental commodities such as books, movies, music software, operating systems, application programs and so on (generically, called as software).

Moreover, the rental machines 3,4 may be integrated into the electronic devices respectively by one of the following ways. The first way is to embed the rental machines 3, 4 inside the casing of electronic devices (PC1) for example as shown in FIG. 1 and electrically connect them to circuits of the electronic devices which realize the functions of the electronic devices themselves. The second way is to electrically connect the rental machines 3,4 to circuits of the electronic devices which realize the function of the electronic devices such that they are integrated into one body through an interface (not shown) such as a connector (and, a receptacle). The third way is to spatially separate the rental machines 3,4 from the electronic devices and electrically or electromagnetically connect the rental machine 3,4 to circuits which realize the functions of the electronic devices through wires or wireless lines.

The rental system shown in FIG. 1 comprises electronic devices such as PCs 1, 2, rental devices 3, 4 integrated into the electronic devices, a mobile communication terminal 7, a management server 11 of a communication service company 9, and information servers SP1-SPn (n is an integer) of companies which compose a group 29 of software providing companies.

The mobile communication terminal 7 transmits specific information to the rental machine 3 when software is rented. The specific information is information associated with the subscriber line of the mobile communication terminal 7. In the present embodiment, an ID (identification) code is used as the specific information.

The rental machine 3 (4) is provided so as to be electrically or electromagnetically integrated into the PC 1 (2). Especially, when the rental machine 3 detects the transmitted ID code, it recognizes that it is a rental request from the mobile communication terminal 7 having the ID code. The customer authentication employing the rental request (ID code) will be described below.

The rental machine 3 performs processing on a rental of software between the mobile communication terminal 7 (or, the PC 1) and the communication service company 9, treating the mobile communication terminal as a charged person for rental fee. Specifically, such processing are performed as confirmation processing for renting (charging) such as selection of the software to be rented, instruction for downloading the software, confirmation of a rental period and charges; confirmation of deletion of the software at rental expiration, rental continuation processing or software deletion processing based on acknowledgment of deletion of the software, and so on.

The PC 1 (2) is, for example, a device used in general households, and. in the present embodiment, has a hardware configuration connectable to communication networks such as the Internet. The PC 1 stores software to be rented in a hard disk 5 and so on, based on instructions from the rental machine 3, and performs reproduction processing of the software and so on. While, in the present embodiment, as shown in FIG. 1, the PC 1 and PC 2 are arranged on different floors in the same building, the present invention is not limited to the this arrangement.

Then, the management server 11 is provided in the communication service company 9 and performs mainly three managements in the present embodiment. Specifically, it performs management of the software under a contract with a group 29 of software providing companies, management of rental histories of customers, and management of charging as described below.

The management server 11 shown in FIG. 1 comprises a controlling part 13, a transmitting/receiving part 15, an input operation part 17, a display part 19, a memory part 21, a contents data base (DB) 23, a customer data base (DB) 25, and a charging data base (DB) 27.

The controlling part 13 is a CPU (central processing unit), which controls the entire operations of the management server 11, based on the programs stored in the memory part 21. The controlling part 13 performs transmission and reception control and update control of the contents DB 23, the customer DB 25, and the charging DB 27, when information on rental commodities corresponding to the rental requests from the mobile communication terminal 7 (the rental machine 3) is provided, the software to be rented is downloaded and charging processing is performed.

The input operation part 17 is a keyboard and so on to input the updated contents of the contents DB 23, the customer DB 25, the charging DB 27, and so on. The data operated by input keys is converted into key codes and inputted to the controlling part 13.

The display part 19 is an LCD (liquid crystal display) and so on to perform display processing by converting transferred code data into display data, based on the instructions from the controlling part 13, when the code data are transferred.

The memory part 21 is a RAM (random access memory), a ROM (read only memory), and so on to temporarily store data required for processing of the management server 11, and to permanently store programs for instructing operations of the management server 11.

The contents DB 23 is a storage device having a large capacity such as a magneto-optical disk library device or the like to perform management of the software as rental commodities. Each of software is stored in association with its product description and charge, and so on. The rental period of each rental commodity is defined in unit of a week, a day, an hour, or the like, and customers may freely choose the rental period.

The customer DB 25 is a storage device having a large capacity like the contents DB 23, to perform management of customer's information which includes their rental histories. Names of customers (ID codes of the mobile communication terminals), names of rental commodities, rental periods, and so on are registered as customer's information.

The charging DB 27 is a storage device having a large capacity like the contents DB 23, to perform management of charging information on rental charges. Names of customers (ID codes of mobile communication terminals), addresses, telephone numbers, charging amounts, deadline of payments, payment methods, and so on are registered as charging information.

Then, the group 29 of software providing companies comprises companies which make a contract for renting software with communication service company 9. Rental software commodities provided by these companies include software provided by various kinds of mass communication such as satellite broadcasting, CATV (cable television), newspaper, radio broadcasting, publication, and so on.

The information server SP1-SPn of each company provides software as rental commodities to the communication service company 9 (in some case, another company of the plural communication service companies). In methods to provide them, they may be periodically downloaded into the contents DB 23 of the management server 11 through communication lines, or may be stored in storage media such as CD-ROMs (compact disk read-only memories), videotapes and so on for sending them by mail so that an operator of the management server 11 stores them in the contents DB 23.

Whereas the management server 11 shown in FIG. 1 is provided with the contents DB 23, each of information data bases SP1-SPn may download software to be rented to the PC 1 directly or through the management server 11 in response to a request from the management server 11 or the mobile communication terminal 7.

FIG. 3 is a block diagram showing a configuration of the rental machine 3 according to the present embodiment. The rental machine 3 comprises a controlling part 31, a transmitting/receiving part 33, a RAM 35, a ROM 37, an input operation part 39, and a display part 41.

The controlling part 31 is a CPU to control entire operations of the rental machine 3 according to the present invention. Especially, it performs communication control of the transmitting/receiving part 33, confirmation control regarding rental (charging), deletion control of software at expiration of the rental and so on.

The transmitting/receiving part 33 performs transmission and reception processing of data concerning software rental (charging) between the mobile communication terminal 7 and the management server 11 (see FIG. 1), based on the instructions from the controlling part 31.

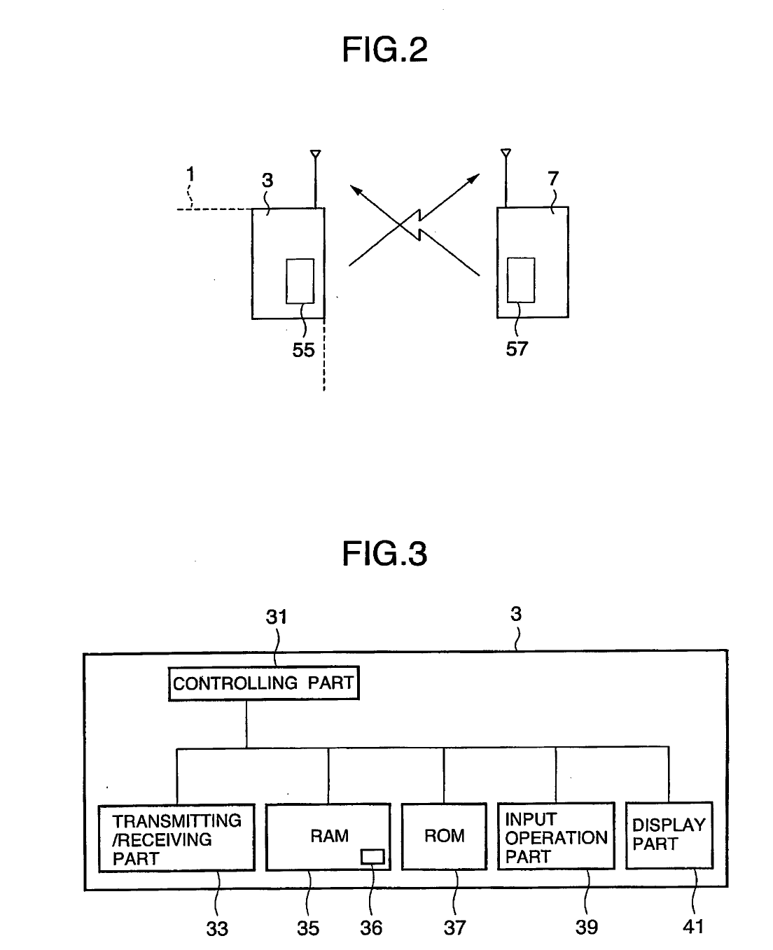

The ROM 37 (see FIG. 2) permanently stores programs for instructing operations of the rental machine 3. The RAM 35 temporarily stores data required for processing the rental machine 3. Especially, the RAM 35 stores rental histories of customers, who have used the PC 1 as a reproducing unit of software, into the history table 36.

The input operation part 39 performs input operations in updating the history table 36, and so on. The inputted operation data are converted into key codes and inputted to the controlling part 13. The display part 41 converts code data into display data, based on the instructions from the controlling part 13, and displays the history table 36 and so on.

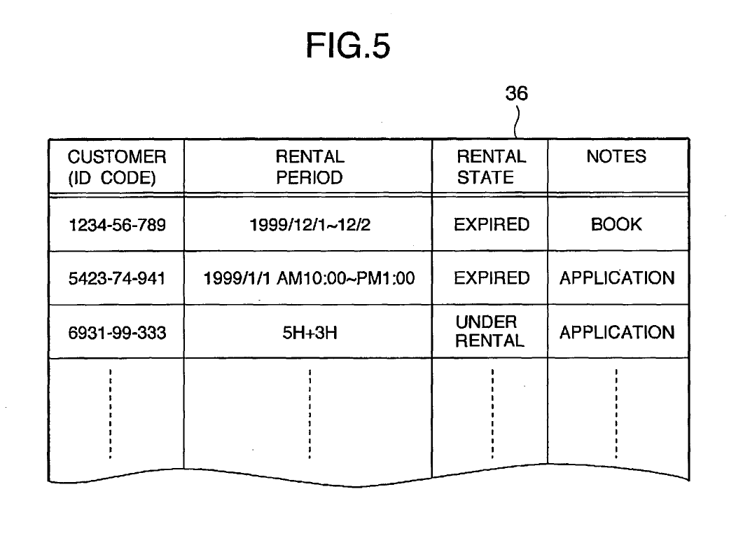

FIG. 5 is a diagram showing an example of the history table 36. The history table 36 stores rental periods and rental states corresponding to customer's names (ID codes of the mobile communication terminal), and, further, “notes” of the table 36 stores types of rented software and so on.

For example, in the example of FIG. 5 it shows that the customer who has an ID code “1234-56-789” had rented a book under the contract of a rental period of “1999/12/1-1999/12/2”, and the contract has already “expired”, judging from its rental state. Also, it shows that the customer who has an ID code “5423-74-941” had rented an application program under the contract of a rental period of “1999/1/1 AM10:00-PM1:00”, and the contract has already “expired”, judging from its rental state. Further, it shows that the customer who has an ID code “6931-99-333” had rented an application program under the contract of a rental period of “5H+3H”. It shows that it had been first rented under the contract such that cumulative operating time was 5 hours after installation, and that the cumulative rental period was extended by cumulative rental times of 3 hours at expiration of the rental contract. The rental is in a state of “under rental”, judging from the rental state.

Here, in the rental states shown in FIG. 5, update methods differs depending on the contract that a rental period is set as “from the beginning to the expiration of the rental contract”, or the contract that a rental period is set as “cumulative operating time after installation”.

In the former case, the controlling part 31 registers a state “under rental” at the beginning of the rental. Then, it performs software deletion processing or rental continuation processing to update the contents of the rental state, based on comparison between the time of a timer means provided (not shown) in or outside the controlling part 31 and the rental period in the history table 36.

In the latter case, the controlling part 31 registers a state “under rental” at the beginning of the rental. Then, it successively accumulates the time of starting up of the software by the timer means and stores it in the RAM 35. Subsequently, it performs software deleting processing or rental continuation processing to update the contents of the rental state, based on comparison between the stored cumulative time and the rental period of the history table 36.

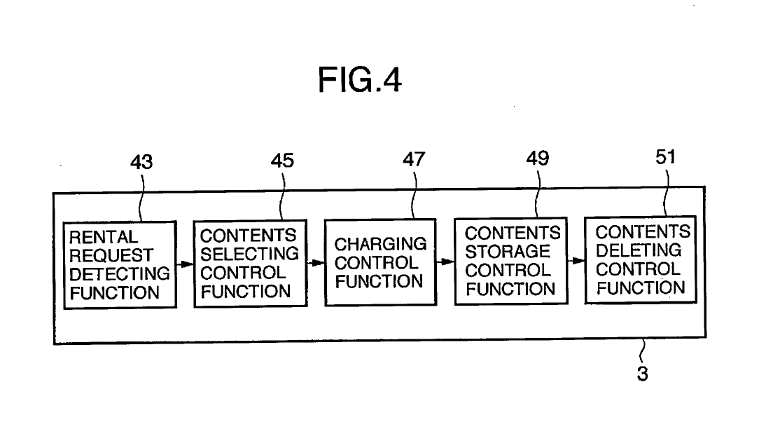

FIG. 4 is a functional block diagram for explaining the functions of the rental machine 3 according to the present embodiment. The functions of the rental machine 3 comprise a rental request detecting function 43, a contents selecting control function 45, a charging control function 47, a contents storage control function 49, and a contents deleting control function 51. These functions are executed based on the instructions from the controlling part 31 shown in FIG. 3.

In the rental request detecting function 43, the transmitting/receiving part 33 receives an ID code from the mobile communication terminal 7, and the received ID code is transferred to the controlling part 31 and is registered in the history table 36. The customer authentication scheme using the ID code will be briefly described below.

FIG. 2 is a diagram showing a customer authentication scheme between the rental machine 3 and the mobile communication terminal 7 according to the present embodiment. As shown in FIG. 2, the rental machine 3 is provided with a label tag 55 that generates a signal specific to the rental machine 3, and, the mobile communication terminal 7 is also provided with a label tag 57 that generates a signal specific to the terminal 7. The operation of label tag 55 for generating a specific signal is independent from that of the rental machine 3, and the operation of label tag 57 for generating a specific signal is also independent from that of the mobile communication terminal 7.

Each of the label tags 55, 57 comprises an IC (Integrated Circuit), an interface such as a Bluetooth connector, and functions as a non-contact type sensor. The above tags generate signals, which are different from those transmitted through the general subscriber line, by each other to perform mutual recognition.

The specific signal generated from the label tag 57 is detected by the transmitting/receiving part 33 (see FIG. 3) of the rental machine 3. The specific signal generated by the label tag 55 is also detected by the receiver (not shown) of the mobile communication terminal 7. If they detect each other, the customer authentication at the time of rental is performed, and the ID code is transmitted from the mobile communication terminal 7. This permits the rental machine 3 to detect the ID code of the mobile communication terminal 7, and allows the holder of the above terminal 7 as a customer for rental to use the PC 1.

Then, in the contents selecting control function 45 (see FIG. 4), the transmitting/receiving part 33 first transmits a rental request (including the ID code) to the management server 11, and the controlling part 31 displays information on rental commodities transmitted from the management server 11 on the display of the PC 1. The information on the rental commodities includes software names, product descriptions, rental periods, charges, and so on. The holder of the mobile communication terminal 7 selects software to be rented and their rental periods by using the PC 1. Further, the transmitting/receiving part 33 transmits the selected software and rental periods to the management server 11.

In the charging control function 47, the controlling part 31 confirms the rental contract, treating the holder of the mobile communication terminal 7 as a customer for the rental, and transmits the confirmation to the management server 11. At this time, the controlling part 31 registers the rental periods of the selected software corresponding to the ID code previously registered in the history table 35. The customer's name (ID code), the software names, the rental periods, and so on are registered in the customer DB 25 of the management server 11. Similarly, the charging amounts and so on together with the customer's name (ID code) are registered in the charging DB 27. The charging amount is added to the line tolls of the mobile communication terminal 7, and the invoice thereof is sent to the customer.

In the contents storage control function 49, the controlling part 31 controls such that software downloaded from the management server 11 is stored in a predetermined hard disk 5 of the PC 1. The processing is executed for example, by storing the software in the hard disk 5 of the PC 1 through the rental machine 3.

In the contents deleting control function 51, the controlling part 31 selectively deletes the software, whose rental period has already expired, from the hard disk 5, based on the time of the timer means provided in or outside the controlling part 31 and the contents of the history table 36. Otherwise, the controlling part 13 in the management server 11 may transmit a deletion instruction to the controlling part 31 of the rental machine 3, based on the time of the timer means provided in or outside the management server 11 and the contents of the customer DB 25.

As for the above charging control function 47, by performing customer authentication based on ID code related to the subscriber line of the mobile communication terminal 7, customer authentication is ensured and becomes easy, when a number of holders of mobile communication terminals use the PC 1 as a software reproducing unit. Moreover, charging processing for customers can be carried out without charging the holder or administrator of the PC 1.

As for the above contents deleting control function 51, the deleting processing is selectively executed at expiration of the rental period, so that the customer does not need to return the rental commodities. Moreover, it is assumed that many holders of the mobile communication terminals use the PC 1 as a software reproducing unit, and a plurality of rental periods for the customers may be controlled by providing the history table 36. In this case, the load of the management server 11 may be reduced, as the rental control of all the electronic devices to be controlled by the management server 11 may be assigned to each rental machine.

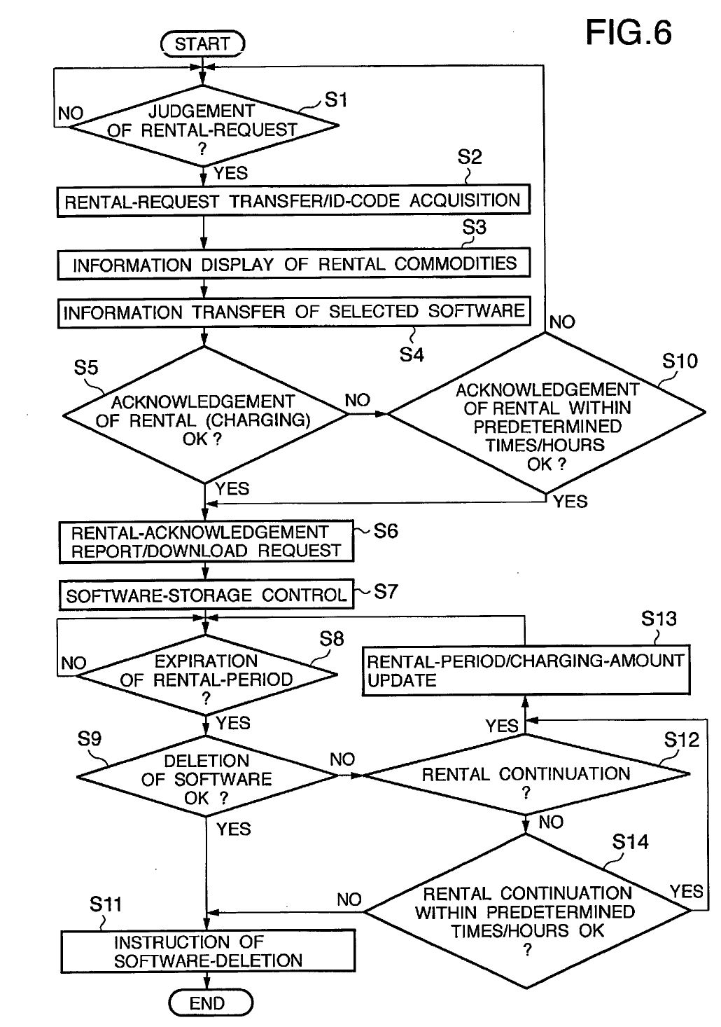

FIG. 6 is a flow chart for explaining operations of the rental machine 3 according to the present embodiment. Here, the flow chart shown in FIG. 6 shows mainly the operations of the rental machine 3.

Firstly, at the step S1, it is judged whether there is a software rental request from the mobile communication terminal 7 or not. Specifically, the mobile communication terminal 7 and the rental machine 3 detect their specific signals by each other within a predetermined distance, and then it receives the ID code from the mobile communication terminal 7.

As shown in FIG. 1, though the rental machine 3 (the transmitting/receiving part 33) on the second floor within a predetermined distance from the mobile communication terminal 7 can detect the above ID code, the rental machine 4 on the first floor residing outside the predetermined distance from the mobile communication terminal 7 can not detect the ID code. Therefore, the software can be downloaded only to the PC 1 which is to reproduce the software to be rented.

Then, at the step S2, the rental request (including the ID code) is transferred to the management server 11 through the subscriber line of the mobile communication terminal 7, and the received ID code is registered in the history table 36. At this time, the controlling part 31 controls the PC1 to become a state of starting up. On the other hand, the management server 11 transmits information on the rental commodities (software names, product descriptions, rental periods, rental charges, and so on) in response to the rental request.

At the step S3, the controlling part 31 controls the PC 1 to display information on the rental commodities from the management server 11 on the display (not shown). As mentioned above, the holder of the mobile communication terminal 7 selects desired software from rental commodities displayed in a form of a list on the display of the PC 1 and selects the rental periods thereof and so on. The rental period of software is selected from either a rental period from the beginning to the expiration of the rental or cumulative operating time after installation.

Then, at the step S4, information on the software selected at the step S3 (software names, rental periods, charges, and so on) is transferred to the management server 11. Here, the management server 11 transmits an acknowledgment request for the rental and charging including the software names, rental periods, charges, and so on.

At the step S5, the controlling part 31 controls the PC 1 to display the above acknowledgement request on the display, and to confirm the rental and the charging. When agreement by the customer is obtained, the agreement is reported to the management server 11 at the step S6 and the download of the desired software is requested. At this time, the ID code, the rental periods, and so on are registered in the history table 36, based on the contents of the acknowledgment. The ID codes, the names of rental commodities, the rental periods, and so on are registered in the customer DB 25 of the management server 11, and the ID codes, the charging amounts, the deadlines, methods of the payments, and so on are registered in the charging DB 27.

At the step S5, when acknowledgement by the customer is not obtained, confirmation of the above rental contract (charging) is made again, at the step S10, and, further, when acknowledgement by the customer is not obtained in the course of the above repeated confirmations by predetermined times or for hours, the processing is returned to the step S1.

Then, at the step S7, the controlling part 31 controls the PC 1 to store the software downloaded from the management server 11 in the hard disk 5 of the PC 1. Upon the completion of the above storing processing, it is reported to the management server 11. The storing processing is executed, for example, by the rental machine 3 controlling the software to be stored in the hard disk 5 of the PC 1 through the rental machine 3 itself. On this processing, the software to be stored is downloaded through the subscriber line of the customer (mobile communication terminal 7).

After the above steps, the customer can freely reproduce the software stored in the PC 1 during the rental period.

At the step S8, it is judged whether the rental period of the software has expired or not. The judging processing may be performed by the management server 11, based on the rental periods registered in the customer DB 25, as mentioned above, or by the rental machine 3 based on the rental periods registered in the history table 36.

If it is judged at the step S8 that the rental period has already expired, acknowledgment items showing whether the software may be deleted or not is displayed on the display, at the step S9. In this processing, after the step S8, the management server 11 may instruct the deletion acknowledgment of the desired software to the rental machine 3, or the rental machine 3 itself may perform the deletion confirmation of the software to the customer If it is judged at the step S8 that the rental period has not expired, the processing will return to the state of the step S8.

Then, at the step S9, if the deletion agreement from the mobile communication terminal 7 is obtained, the deleting processing of the desired software is performed at the step S11. If the deletion agreement is not obtained, it is judged, at the step S12, whether the rental contract is continued or not.

If the agreement of rental continuation is obtained at the step S12, continuation of the rental is reported to the management server 11, and, then, at the step S13, the rental period in the history table 36, the rental period, the charging amount and so on in the customer DB 25 and the charging DB 27 are updated. Then, the processing is returned to the step S8.

The rental continuation processing at the step S13 is performed, for example, by confirming the customer of the extended rental period from the management server 11 and all the charging amounts including the charges for the above extended period after the report of the rental continuation at the step S12.

At the step S12, if the agreement of rental continuation is not obtained, the above confirmation of the rental continuation is performed again at the step S14, and, further, if the agreement is obtained in the course of the above repeated confirmations by predetermined times or for hours, the processing goes to the step S13. Moreover, if the agreement is not obtained, the processing goes to the step S11.

Finally, at the step S1, the desired software is deleted from the hard disk 5 of the PC 1. Of course, the customer may instruct the rental machine 3 to delete the software before the rental period expires. In either case, the rental machine 3 instructs the PC 1 to perform the final deleting processing.

As mentioned above, the rental machine according to the present embodiment performs the authentication of rental (charging) with the management server 11 for mobile communication terminal (portable telephone, PHS (Personal Handy System) or PDA (Personal Digital Assistant), and so on), by which applications for rental may be made through the Internet. Moreover, when a number of customers share an electronic device as a reproducing unit for rental commodities, provision of the history table 36 can reduce the processing load of the management server 11.

The rental machine according to the present invention is not necessarily limited to the above embodiments and, changes or modifications of the above configuration and/or operations, and further extensions of the above functions can be made based on the above embodiments.

While the rental machines 3, 4 discussed in the above embodiments may be used by installing programs for instructing operations according to the present invention in a general mobile communication terminal (portable telephone or the like) with the subscriber line which is not a telephone (with the subscriber line) under a contract with a communication business company.

Whereas, in the above embodiment, the hard disk 5 is shown as a storage device for storing the software to be downloaded, the software may be stored, for example, in a RAM (not shown) provided in the PC 1, or in external memory devices such as a magneto-optical disk device (not shown), and so on.

Further, at the step S7 of the above embodiment (see FIG. 6), a deleting program to confirm extension of the rental at expiration of the rental period and to selectively instruct deleting of the rental software may be added to the software to be downloaded.

In this case, the controlling part 31 starts up the deletion program in response to the software downloading. Especially, when the rental period is shown as “from the beginning to the expiration of the rental” in the deleting program, the controlling part 31 asks an acknowledgment of deletion to the customer at expiration of the rental period. On the contrary, when the rental period is shown as “the cumulative operating time after installation” in the deleting program, the starting times are accumulated each time in the RAM 35, and the controlling part 31 asks an acknowledgment of deletion to the customer after the elapse of cumulative operating time. In either case, the controlling part 31 of the present invention selectively performs the deleting processing of the software at the expiration of the rental contract.

Furthermore, in the above embodiments, two contract forms are shown as the rental period, but, by setting a contract period suitable for rental commodities, conveniences of the customers may be improved.

For example, browser software such as the Microsoft's Internet Explorer® or the Netscape Navigator® is not necessarily installed according to the present invention. When a portable telephone and so on is to be connected to the Internet, the browser software is downloaded in packets by rental request to a software provider, and it may be automatically deleted at completion of the access to the provider. When the software is a movie, a book, or the like, the deleting processing may be performed based on the elapse of time, or the number of usage times after downloading.

In this case, for example, at the steps S4 and S5 (see FIG. 6), the acknowledgment of rental period and charges is not performed and the management server 11 calculates the rental charges after processing of the step S10, based on the real rental period (contract period) from installation to the rental expiration (at the software deleting). Further, a processing for transmitting the calculated amount to the rental machine 3 and for asking the customer to acknowledge the charging amount may be provided.

Furthermore, while in the above embodiments, such a case that the holder of the mobile communication terminal 7 rents software, and the software is directly downloaded to the PC 1 of an electronic device for reproduction is described, the electronic device for reproduction may be the mobile communication terminal 7. In this case, the mobile communication terminal 7 directly exchanges the rental data with the management server 11 through its subscriber line.

Practically, as shown in the above embodiments, the rental data are data for selecting the software to be rented, a rental period and so on, data which shows acknowledgment of rental (charging); data for instructing the software to be downloaded into the storage means (not shown) of the mobile communication terminal 7, data for instructing the acknowledgment of the deletion of software; and so on. In this case, the software downloaded to the mobile communication terminal 7 may be stored in the hard disk 5 of the PC 1 by using the function of the label tags 55, 57 (see FIG. 2).

In the above embodiment, the rental machine 3 is described as a device separate from the electronic device (PC1), but the rental machine 3 of the present invention may be so composed that a configuration of the electronic device includes the corresponding one of the rental machine 3 (see FIG. 3). For example, the controlling part (not shown) of the PC 1 may execute operations of the controlling part 31 of the rental machine 3.

When the PC 1 has an ID code, the direct rental request may be made to the management server 11. A customer may execute selection of the software, acknowledgment of rental, and so on directly with the management server 11 through the subscriber line of the PC 1 and may download transferred software to the PC 1.

In this case, the controlling part of the PC 1 (the controlling part 31 of the rental machine 3) controls the hard disk 5 to store the software and displays a deletion acknowledgment on the PC 1, and then selectively deletes the software based on instructions of software deleting, transferred from the management server 11 at expiration of the rental contract.

In step S11 and step S14 of the above embodiment, if it fails in expressing the intention of rental continuation, the software is deleted. However, even in this case, warning may be previously generated, and if there is a current file, it may be stored. In this way, even when it is impossible to get permission due to troubles, it would not give rise to serious problem, as it is enough to merely make a rental again.

Moreover, as far as a provider does not give permission, execution of the software may be prevented, instead of deletion of the software. In this case, the programs to delete the software may be designed to be executed even without permission, and the main body of programs may be designed not to be executed, without permission. The programs to obtain the permission may also be designed to be executed even without permission.

Further, the rental machine according to the present invention may be realized by a program for operating the rental machine. The program is being stored in a computer-readable storage media such as a CD-ROM.

The storage medium which stores programs for executing operations of the rental machine 3 may be the ROM 37 itself shown in FIG. 3, or a CD-ROM, which is inserted into program reading devices to be read such as a CD-ROM driver (not shown) provided as an external memory device, and so on. The above storage medium may be a magnetic tape, a cassette tape, a floppy disk ®, a hard disk, a MO (magneto-optical disk), a MD (mini disk), a DVD (digital versatile disk), a semiconductor memory, or the like.

### 6. INDUSTRIAL APPLICABILITY

According to the present invention, customer authentication and charging processing may be performed exactly in renting software which is available through communication networks such as the Internet.

Software which are occasionally used and are not necessarily installed permanently such as one for making a New Year's card may be rented if needed. This provides a great convenience to the customers, as well as overcomes the limitation of memory capacity caused by downsizing the mobile communication terminal and so on.

What is claimed is:

1. A rental machine comprising:
storage means for storing software in an electronic device which reproduces said software; and
deleting means for deleting said software stored in said electronic devices, at expiration of a rental contract.

2. The rental machine according to claim 1, wherein said rental machine further comprises detecting means for detecting information on the subscriber line and said storage means stores said software through the subscriber line corresponding to the information detected by said detecting means.

3. The rental machine according to claim 1, wherein said rental machine further comprises continuation means for asking an acknowledgment of rental continuation at expiration of said rental contract, said deleting means defers deletion of said software, when the confirmation of rental continuation is made by said continuation means.

4. A rental machine comprising:
storage means for storing software in an electronic device which reproduces said software; and
preventing means for preventing starting of said software stored in said electronic device at expiration of a rental contract.

5. A computer-readable storage medium storing programs to make a computer operate as a rental machine according to claim 1 or 4.
